(19) United States
(12) Patent Application Publication
(10) Pub. No.: US 2022/0254162 A1
(43) Pub. Date: Aug. 11, 2022

(54) DEEP LEARNING FRAMEWORK FOR CONGESTION DETECTION AND PREDICTION IN HUMAN CROWDS

(71) Applicants: Emad FELEMBAN, Makkah (SA); Sultan Daud KHAN, Makkah (SA); Atif NASEER, Makkah (SA); Faizan Ur REHMAN, Makkah (SA); Saleh BASALAMAH, Makkah (SA)

(72) Inventors: Emad FELEMBAN, Makkah (SA); Sultan Daud KHAN, Islamabad (PK); Atif NASEER, Makkah (SA); Faizan Ur REHMAN, Makkah (SA); Saleh BASALAMAH, Makkah (SA)

(73) Assignee: UMM AL-QURA UNIVERSITY, Makkah (SA)

(21) Appl. No.: 17/667,277

(22) Filed: Feb. 8, 2022

Related U.S. Application Data
(60) Provisional application No. 63/148,015, filed on Feb. 10, 2021.

(51) Int. Cl. G06V 20/52; G06T 7/215; G06V 20/40; G06V 10/774; H04N 7/18; G06N 3/04

(52) U.S. Cl. CPC G06V 20/53; G06T 2207/20084; G06V 20/49; G06V 10/7747; G06V 20/41; H04N 7/18; G06N 3/0445; G06T 2207/30241; G06T 2207/20081; G06T 2207/20068; G06T 2207/20072; G06T 2207/10016; G06T 2207/20021; G06T 2207/30232; G06T 7/215

(57) ABSTRACT

Approaches describe detecting and predicting crowd congestion in real-time for large gatherings, for example large religious mass gatherings. Approaches may utilize image and/or video data, and/or pedestrian trajectory data. The various pieces of information may be identified, extracted, and/or determined from a variety of different disaggregated sources and may be aggregated, and/or determined to generate a congestion detection score and/or score map that is indicative of the degree of crowd congestion in a geographic region and can forecast future crowd congestion in the geographic region. Approaches may be used to monitor a crowd to prevent or mitigate crowd disasters. Moreover, approaches may be used by crowd management entities to timely detect congested regions and manage the crowd efficiently.

### CROSS-REFERENCE TO RELATED APPLICATIONS

The present application claims priority to U.S. provisional application No. 63/148,015, filed Feb. 10, 2021, and entitled “DEEP TRAJECTORY CLASSIFICATION MODEL FOR CONGESTION DETECTION IN HUMAN CROWDS,” which is hereby incorporated herein in its entirety for all purposes.

### BACKGROUND

### Field of the Art

This disclosure relates to systems and methods for real-time detection and prediction of crowd congestion in large gatherings. Increased urban population and development of new infrastructures can lead to instances where large numbers of participants gather in limited spaces. In high density gatherings, such as crowds of people, vehicles, animals, etc., attending concerts, political and religious processions, festivals, sports events, and so forth, crowd disasters can occur. Crowd disasters may include injury or casualty resulting from crowd congestion in a particular area. For example, a religious event during Hajj in 2015 experienced more than 700 casualties directly related to crowd congestion. Similar crowd disasters occurred during other events, such as the Love Parade event of 2010 in Germany and religious processions in Baghdad of 2005.

To prevent crowd disasters, the crowded scene must be monitored. Surveillance cameras may be installed in various locations to monitor crowds within the environment. Conventional methods may measure crowd congestion by estimating the crowd density or counting the crowd density. Such methods involve manual analysis of the crowd. However, manual crowd analysis is highly susceptible to errors. Moreover, crowd density alone cannot provide relivable information about congested regions in a crowded scene. Other conventional approaches may include implementing experiments, for example, manually analyzing recorded videos and employing simulation models to simulate the behavior of pedestrians, such as to identify and predict choke points. However, such empirical studies and simulation models are limited in two ways. First, simulation cannot cover different real-time crowd situations simultaneously. Second, such models cannot provide precise results, but rather, only provides limited responses to different input parameters. Accordingly, it is desirable to have improved methods for real-time detection of congestion in high density crowds and prediction of future congestion.

### SUMMARY

The present invention is for systems and methods for detecting and predicting crowd congestion in real-time for large gatherings, for example large religious mass gatherings. The present invention may utilize the following information, including, but not limited to: image and/or video data, and/or pedestrian trajectory data (hereinafter sometimes referred to as trajectory data or point trajectory data). The various pieces of information may be identified, extracted, and/or calculated from a variety of different disaggregated sources and may be aggregated, and/or calculated to generate a congestion detection score and/or score map that is indicative of the degree of crowd congestion in a geographic region and can forecast future crowd congestion in the geographic region. The congestion detection system may be used to monitor a crowd to prevent or mitigate crowd disasters. Moreover, the congestion detection system may be used by crowd management entities to timely detect congested regions and manage the crowd efficiently.

The present invention is described herein primarily in reference to large crowd gatherings such as religious gatherings, concerts, festivals, political events, sports events, etc. However, elements of the present invention may be applied to other situations involving large crowds or high densities of people occupying a space, including, but not limited to, traffic management, urban development, public health and disease prevention, transportation management, animal migration, video game players, etc., without departing from the scope of the invention.

In one embodiment of the invention, the present invention collects image data, such as video data, from various sources. Video data provides images showing crowd behavior within an area over time. Moreover, the video data provides information about the trajectories of individuals in a crowd over a time period within an area. The present invention, in accordance with an embodiment of the invention, extracts trajectory information about individuals in a crowd and analyzes and learns the motion information from the trajectories to detect and predict congestion in the crowd.

In an embodiment, the present invention may divide the video data (e.g., video stream) into temporal segments. The temporal segments may be of equal size. Optical flow may be calculated between consecutive frames in each segment. Optical flow may be determined by interest point tracking and/or dense optical flow tracking. Optical flow field is computed between each consecutive frame of the temporal segment to obtain trajectories of the crowd individuals depicted in the temporal segment.

In one embodiment, the present invention may extract trajectories from the resulting set of flow fields using particle advection. A 2D grid of points may be overlaid over a current flow field (e.g., current frame), where each point initiates a trajectory. The trajectories are concatenated over corresponding points in subsequent flow fields (subsequent frames). The extracted trajectories may be collected and stored as a set of trajectories.

In one embodiment, the point trajectories in each segment may be projected onto a 2D plane to generate an oscillatory image (e.g., 2D image). The oscillatory image may be a compressed representation of the video's temporal information. Therefore, the oscillatory image may represent the time and space features of a trajectory as a 2D image. The resulting 2D image may be an acceptable input for training a segmentation network (e.g., learning model, neural network framework), which accepts 2D images but not point trajectories.

In one embodiment of the invention, scores may be assigned to each trajectory projected on the oscillatory image. For example, a high score may suggest a congested trajectory and a low score may suggested normal (uncongested) trajectory. A score map is generated based on the scores collected from all trajectories in the area of the oscillatory image. The score map may display regions where there is crowd congestion. A visualization, such as an interactive virtualized map, may display the congestion detection to a user.

In one embodiment of the invention, the present invention may localize the area where congestion is detected. A time series list of the areas from multiple temporal segments may be generated and fed into a learning model, for example, a long short-term memory (LSTM) model. The LSTM model may be trained to predict potential congestion based on, for example, the congestion patterns in the time series. The predicted congestion may be displayed and checked for accuracy.

In some aspects, the techniques described herein relate to a computing system, including: a computing device processor; and a memory device including instructions that, when executed by the computing device processor, enables the computing system to: segment a length of video data into a plurality of temporal segments, determine a set of optical flow fields for each of the plurality of temporal segments, extract a plurality of trajectories from each optical flow field of the set of optical flow fields, convert the plurality of trajectories into a training set of oscillatory images by projecting the plurality of trajectories onto a two-dimensional (2D) plane, analyze the training set of oscillatory images to determine a score for each of the plurality of trajectories, the score indicating a degree of congestion, generate a score map to classify whether a geographic region of a temporal segment is congested, and graphically representing at least one classification to visually specify a level of congestion for the geographic region.

In some aspects, the techniques described herein relate to a computing system, wherein the instructions, when executed by the computing device processor, further enables the computing system to: train a long short-term memory model to predict future congestion.

In some aspects, the techniques described herein relate to a computing system, wherein the instructions, when executed by the computing device processor, further enables the computing system to: provide a visualization of congestion in an interactive dashboard in real-time.

In some aspects, the techniques described herein relate to a computing system, wherein each of the plurality of temporal segments includes a fixed size, the fixed size defined by a number of frames of the video data.

In some aspects, the techniques described herein relate to a computing system, wherein each oscillatory image from the set of oscillatory images is a binary image.

In some aspects, the techniques described herein relate to a computing system, wherein the instructions, when executed by the computing device processor, further enables the computing system to: calculate an optical flow field between every two consecutive frames of each temporal segment.

In some aspects, the techniques described herein relate to a computing system, wherein extracting the plurality of trajectories from each optical flow field further includes concatenating an initial point in a first frame of the temporal segment with a corresponding point in a second frame of the temporal segment.

In some aspects, the techniques described herein relate to a computing system, wherein the instructions, when executed by the computing device processor, further enables the computing system to: select the geographic region of the temporal segment, generate a time series list of geographic regions from the plurality of temporal segments, and feed the time series list to a long short-term memory model.

In some aspects, the techniques described herein relate to a computing system, wherein the score may be determined by a segmentation network, the segmentation network to classify each pixel in a trajectory from the plurality of trajectories as one of congested or uncongested.

In some aspects, the techniques described herein relate to a computing system, wherein a congested classification corresponds to when the score exceeds a density threshold.

In some aspects, the techniques described herein relate to a non-transitory computer readable storage medium storing instructions that, when executed by at least one processor of a computing system, causes the computing system to: segment a length of video data into a plurality of temporal segments, determine a set of optical flow fields for each of the plurality of temporal segments, extract a plurality of trajectories from each optical flow field of the set of optical flow fields, convert the plurality of trajectories into a training set of oscillatory images by projecting the plurality of trajectories onto a two-dimensional (2D) plane, analyze the training set of oscillatory images to determine a score for each of the plurality of trajectories, the score indicating a degree of congestion, generate a score map to classify whether a geographic region of the temporal segment is congested, and graphically representing at least one classification to visually specify a level of congestion for the geographic region.

In some aspects, the techniques described herein relate to a non-transitory computer readable storage medium, wherein the instructions, when executed by the at least one processor, further enables the computing system to: train a long short term memory model to predict future congestion.

In some aspects, the techniques described herein relate to a non-transitory computer readable storage medium, wherein the instructions, when executed by the at least one processor, further enables the computing system to: provide a visualization of congestion in an interactive dashboard in real-time.

In some aspects, the techniques described herein relate to a non-transitory computer readable storage medium, wherein each of the plurality of temporal segments includes a fixed size, the fixed size defined by a number of frames of the video data.

In some aspects, the techniques described herein relate to a non-transitory computer readable storage medium, wherein each oscillatory image from the plurality of oscillatory images is a binary image.

In some aspects, the techniques described herein relate to a non-transitory computer readable storage medium, wherein the instructions, when executed by the at least one processor, further enables the computing system to: calculate an optical flow field between every two consecutive frames of each temporal segment.

In some aspects, the techniques described herein relate to a non-transitory computer readable storage medium, wherein the extracting the plurality of the trajectories from each optical flow field further includes concatenating an initial point in a first frame of a temporal segment with a corresponding point in a second frame of the temporal segment.

In some aspects, the techniques described herein relate to a non-transitory computer readable storage medium, wherein the instructions, when executed by the at least one processor, further enables the computing system to: select the geographic region of a temporal segment, generate a time series list of geographic regions from the plurality of temporal segments, and feed the time series list to a long short-term memory model.

In some aspects, the techniques described herein relate to a non-transitory computer readable storage medium, wherein the score may be determined by a segmentation network, the segmentation network to classify each pixel in a trajectory as one of congested or uncongested.

In some aspects, the techniques described herein relate to a non-transitory computer readable storage medium, wherein a congested classification corresponds to when the score exceeds a density threshold.

One benefit of the present invention is that it is helpful to crowd management entities, as real-time detection of congestion in human crowds can help prevent crowd disasters. Currently, vision-based frameworks for detecting congestion cannot detect or predict the congestion in real-time. Rather, conventional techniques manually analyze recorded videos of crowds and count crowds manually, leading to high error rates when analyzing crowds on a large scale. Conventional techniques also apply various simulation models to simulate the behavior of crowd individuals (e.g., pedestrians), but simulations cannot cover different real-time crowd situations simultaneously. The present invention uses vision-based deep learning to ingest current crowd behavior data and detect and predict congestion in real-time.

Another benefit of the present invention is to reduce computational cost of dense flow tracking (optical flow) of image data. Generally, dense flow tracking causes huge computational cost. Since flow vector is computed for every pixel, and optical flow is sensitive to illumination changes, a small change in illumination can cause a large change in the flow vector. The present invention can reduce computational cost of dense flow tracking, for example, by sampling anchor points from a grid overlaid over subsequent frames of the video sequence, and concatenating trajectories from corresponding anchor points between the frames.

Yet another benefit of the present invention is to reduce the computation time of predicting congestion. Delayed predictions are not helpful in crowd management and can fall behind real-time prediction of congestion. The present invention may learn and process images on independent processor parallelly to reduce computation time and thus allow for making predictions in real-time.

Yet another benefit of the proposed software component is to develop interactive dashboard to visualize the real-time congestion and prediction that will help decision-makers or responders be in a state of preparedness to handle any mishappening.

### BRIEF DESCRIPTION OF THE DRAWING FIGURES

Various embodiments in accordance with the present disclosure will be described with reference to the drawings, in which:

FIG. 1 illustrates a system for detecting and predicting crowd congestion in real-time in accordance with an embodiment of the invention.

FIG. 2 illustrates the congestion detection system in accordance with an embodiment of the invention.

FIG. 3 illustrates the congestion prediction system in accordance with an embodiment of the invention.

FIG. 4 illustrates a flowchart for detecting and predicting crowd congestion in real-time in accordance with an exemplary embodiment of the present invention.

FIG. 5 illustrates an example process for detecting and predicting crowd congestion in real-time in accordance with an embodiment of the invention.

FIG. 6 illustrates an alternative example process for detecting and predicting crowd congestion in real-time in accordance with an embodiment of the invention.

FIG. 7 illustrates an exemplary computing device that supports an embodiment of the inventive disclosure.

FIG. 8 illustrates an exemplary standalone computing system that supports an embodiment of the inventive disclosure.

FIG. 9 illustrates an embodiment of the computing architecture that supports an embodiment of the inventive disclosure.

FIG. 10 illustrates an exemplary overview of a computer system that supports an embodiment of the inventive disclosure.

### DETAILED DESCRIPTION

Systems and methods in accordance with various embodiments of the present disclosure may overcome one or more of the aforementioned and other deficiencies experienced in conventional approaches to detecting and predicting congestion in large gatherings, such as crowds. The inventive system and method (hereinafter sometimes referred to more simply as “system” or “method”) described herein uses image data (such as video streams) of crowds, divides the image data into segments, computes optical flow between frames of the video segments, extracts trajectory data of crowd individuals and trains a neural network to classify the crowd trajectories as congested or normal. More succinctly, the present invention is a system and method for detecting and predicting crowd congestion in real-time based on trajectory data (e.g., motion data) of crowd individuals. The system is a computer program product which collects, converts, extracts, and encodes trajectory data from video stream data and trains the neural network to accurately detect congestion and predict future congestion based on previous congestion patterns.

Different behaviors of a crowd can lead to congestion. These behaviors may include, for example, evacuation, jostling, conflict, and blockage, among others. For example, during an evacuation process, participants in a crowd may attempt to leave a venue, such as at a train station, through a single and narrow exit, causing congestion at the exit. In another example, during jostling, crowd participants may push each other to make their way out. Congestion arises when two or more large group of people come face to face each other in a narrow passage. In various embodiments, the system may detect such congestion and predict future congestion.

In an embodiment, system obtaining video data (e.g., real-time video sequences) of a crowded scene. The video data is divided into temporal segments, Optical flow for each temporal segment is determined, for example, through interest point tracking and/or dense optical flow tracking. In an embodiment, the process calculates the optical flow between every two consecutive frames of the temporal segment, resulting in a set of flow fields that capture motion information in each temporal segment. A flow vector may be calculated for every pixel of an image in a frame of the temporal segment, which provides for more informative (e.g., denser) trajectories extracted from the segment.

The system extracts point trajectories for each temporal segment. Point trajectories may be extracted from the set of flow fields. Particle advection may be used to overlay a 2D grid of points over the first flow field. A point trajectory may be initialized at each point (e.g., anchor points) of the first flow field (e.g., current time frame). The point trajectory will evolve (e.g., concatenate) with points of subsequent flow fields (time frames). The extracted point trajectories will be collected as a set of point trajectories for the temporal segment.

The system generates an oscillatory image based on the extracted trajectories, so that the motion information from the trajectories is in an acceptable format for a CNN-based training model which accepts 2D images (e.g., a segmentation network). The oscillation value of each trajectory is calculated, and the point trajectories are projected on a 2D plane. The resulting oscillatory image may be a spatial-temporal image representing the time and space features of a trajectory as a 2D image. The oscillatory image may be a binary image (e.g., containing two channels, black and white).

In various embodiments, the system may assign a score to each point of each trajectory. The scores are collected to generate a confidence map. The spatial-temporal image (oscillatory image) is classified by the confidence map value as congested or normal. The values of the score map may vary from 0 to 1, where 0 represents a normal trajectory and 1 represents a congested trajectory. Once the score map is generated, a non-maximum suppression (NMS) method may be utilized to suppress low score values. A Gaussian filter may be applied to the score map, and the score map is overlaid over the video segment image (e.g., a scene of the segmented video stream, creating segmented images.

In an embodiment, the system localizes (e.g., identifies the area of) the segmented images and normalizes the area of the congested regions. Based on the normalized segmented images, the system generates a time series list of the areas from the multiple temporal segments. The time series is fed into a long short-term memory (LSTM) learning model. The system may train the LSTM learning model to predict potential congestion based on the congestion patterns in the time series. Each segmented image may be processed on an independent processor parallelly to reduce computation time and to allow for making predictions in real-time. The system may display information about the congestion prediction. The information may be provided, for example, through an interactive dashboard. The congested regions may be overlaid over a real-time map, and can be color-coded to indicate areas of congestion or no congestion.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

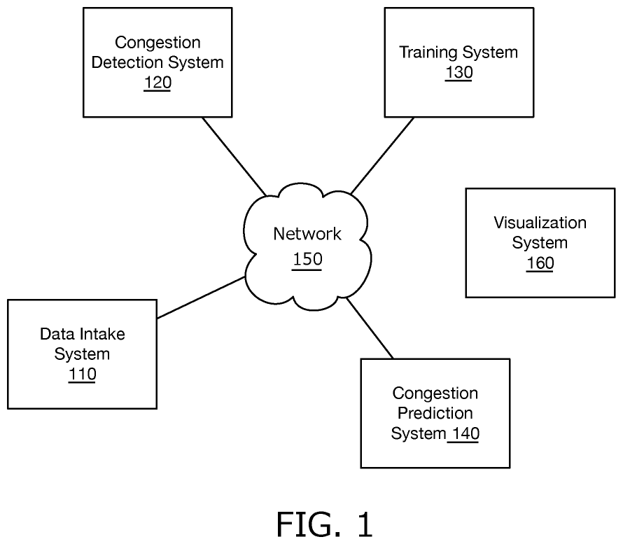

FIG. 1 illustrates a system for detecting and predicting crowd congestion in real-time in accordance with an exemplary embodiment of the invention. The system is comprised of data intake system 110, congestion detection system 120, training system 130, congestion prediction system 140, visualization system 160, and a network 150 over which the various systems communicate and interact. Data intake system 110 collects image data of a crowd, e.g., video stream of a crowd in an area. Image data may be received from a variety of different sources and proprietary databases. For example, image data may be received from surveillance footage, balloons, drones, etc.

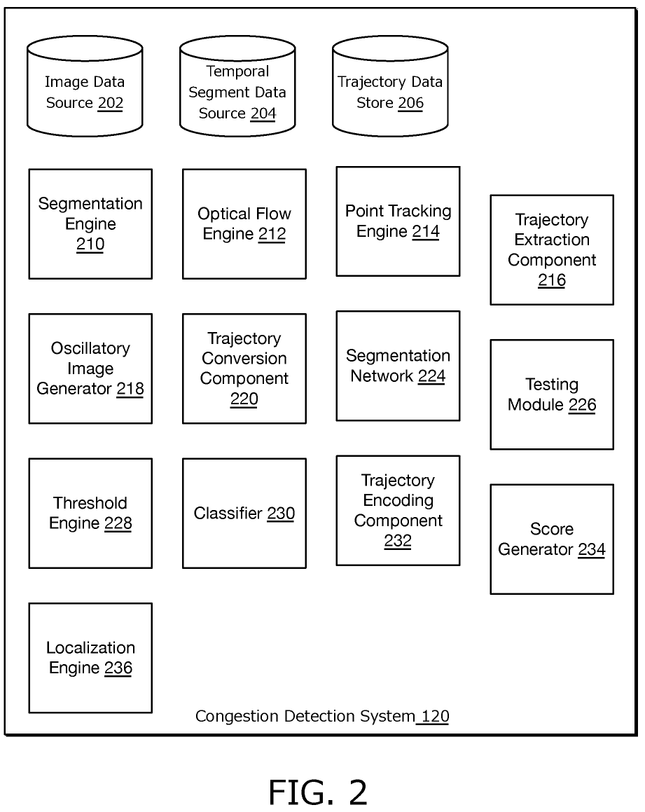

Congestion detection system 120 is described in greater detail in FIG. 2, however, generally, congestion detection system 120 manipulates the image data to obtain motion data (e.g., trajectories) of individuals in a crowd, to determine the level of congestion in an area. In an exemplary embodiment, congestion detection system 120 divides the video stream from data intake system 110 into temporal segments, extracts motion data (e.g., trajectories) of individuals of the crowd from each of the temporal segments, and converts the trajectories into two-dimensional (2D) images, for example spatial-temporal images (also referred to as trajectory images), to feed into training system 130. A spatial-temporal image may include a binary image containing connected points (e.g., coordinates) of the trajectory, where the binary image is a 2D representation of motion data of fixed size which can be accepted by training system 130. In another embodiment, the 2D images may include oscillatory images. Oscillatory images may be generated by calculating an oscillation value for each trajectory and projecting the set of trajectories onto a (2D) plane. Congestion detection system 120 then encodes the trajectories with a classification score, and generates a score map to visualize and localize areas of crowd congestion. The classification score may be based on a level of confidence of the degree of congestion of each trajectory. The system may be reorganized or consolidated, as understood by a person of ordinary skill in the art, to perform the same tasks on one or more other servers or computing devices without departing from the scope of the invention.

Training system 130 trains a classification model to predict congestion in the future. Training system 130 may utilize spatial-temporal images to train a classification model based on Convolutional Neural Network (CNN). As input for CNN generally includes fixed sized inputs, training system 130 obtains spatio-temporal images (e.g., 2D images converted from trajectories by congestion detection system 120; also referred to as trajectory images). Training system 130 may learn spatial features of the converted trajectories. Spatio-temporal images have limited features (e.g., may be a binary image containing points of a trajectory, having limited information of texture, color block, appearance, etc.; and because the spatial-temporal image displays the connected trajectory points, most of the image is blank). However, CNN typically learns from natural RGB image inputs, which are more complex than spatial-temporal images and contain rich texture and high frequency components. As spatial-temporal images lack texture and color information, spatial-temporal images belonging to different classes may appear similar. Therefore, spatial-temporal images may have large intraclass similarities compared to natural RGB images. Training system 130 can still distinguish the classes of the spatial-temporal images.

In another embodiment, training system 130 may utilize oscillatory images to train a binary segmentation network to segment the oscillatory images and to classify each pixel of the oscillatory image into two classes (e.g., congested or normal). Areas within the segmented images may be analyzed and normalized. Training system 130 may feed a time series list of the areas into a long short-term memory (LSTM) learning model and train the LSTM model to predict future congestion.

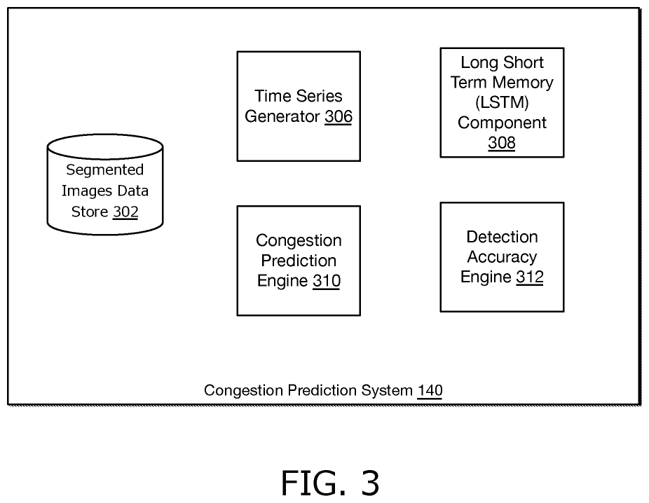

Congestion prediction system 140 is described in greater detail in FIG. 3 below, however, generally, congestion prediction system 140 intakes a time series list of areas (e.g. localized regions) from the temporal segments (e.g., segmented video streams of crowd density in an area), predicts future congestion of the area, and visualizes the prediction (e.g., displays chart of degree of congestion at various future time intervals). In an embodiment, congestion prediction system 140 may analyze the area of the temporal segment and normalize the area. Congestion prediction system 140 may feed the time series list of the areas of each temporal segment into the LSTM learning model. The LSTM model may predict future congestion for each area of the time series list.

Visualization system 160 may comprise a display to present information associated with the congestion detection system 120 and/or congestion prediction system 140. For example, a score map generated by congestion detection system 120 may be displayed with color coding to indicate regions of crowd congestion or normal crowd density. Visualization system 160 may comprise a user interface (e.g., interactive dashboard) to allow a user to provide feedback to or interact with the congestion detection system 120 and/or congestion prediction system 140.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to clients devices or other devices in response to HTTP or other requests from clients devices or other devices. A mail server is generally capable of providing electronic mail services to various clients devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiment, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

FIG. 2 illustrates an exemplary embodiment of the congestion detection system 120. As described in FIG. 1, the congestion detection system 120 extracts trajectories of individuals in a crowd from image data (e.g., video stream data), and employs computer vision and machine learning to detect crowd congestion in a scene based on trajectory data. A scene may include a scene layout (e.g., roads, buildings, sidewalks, etc.), motion patterns (e.g., pedestrians crossing, vehicles turning, etc.), scene status (e.g., crowd congestion, crowd splitting, crowd merging, etc.), a combination thereof, and so forth. Congestion detection system 120 examines a scene which includes a crowd (for example, of individuals, vehicles, animals, etc.) and determines whether a particular area within the scene demonstrates crowd congestion. The crowded scene may be a complex scene, meaning conventional image processing of the scene may experience disturbances to object detection and tracking due to background clutter, diverse configuration in layouts and appearances, illumination changes, occlusions, object distortion, etc. that can result from the presence of a high-density crowd in the area. The congestion detection system 120 includes image data store 202, temporal segment data store 204, trajectory data store 206, segmentation engine 210, optical flow engine 212, point tracking engine 214, trajectory extraction component 216, oscillatory image generator 218, trajectory conversion component 220, segmentation network 224, testing module 226, threshold engine 228, classifier 230, trajectory encoding component 232, score generator 234, and localization engine 236. The congestion detection system 120 may also include a training data store. Other generators, parameters, modules and interfaces may be used, as would be readily understood by a person of ordinary skill in the art, without departing from the scope of the invention.

Image data store 202, temporal segment data store 204, and trajectory data store 206 are illustrated within congestion detection system 120 for illustration purposes. They may reside inside or outside the congestion detection system 120, as would be readily understood to a person of ordinary skill in the art. Exemplary image data stores 202 include a database for storing image data, for example, video streams of crowded scene, such as the movement of a large gathering of subjects, for example, people, vehicles, animals, and so forth. Image data may include real-time streaming footage of the crowded scene in a particular location. Image data may be collected from a media source such as a camera, drone, balloon, and the like. Exemplary temporal segment data store 204 may include a database for storing temporal segments of a divided video stream. Exemplary trajectory data store 206 may include a database for storing trajectory data of individuals in a crowd. Other databases may be used, as would be readily understood to a person of ordinary skill in the art, without departing from the scope of the invention.

Segmentation Engine 210 may divide an input video stream into a plurality of temporal segments. The size of a temporal segment may be determined by the number of frames (e.g., N frames) per segment. The temporal segments may of equal duration (e.g., of a fixed size, N). In an embodiment, the temporal segments may be temporally overlapping. For example, a first temporal segment (e.g., t₀) and second temporal segment (t₁) may be of equal size (e.g., both having a length of N frames), where at least a final frame in the first temporal segment (e.g., t₀) is the same as at least a first frame in the second temporal segment (t₁). The temporal segments are stored in temporal segment data store 204.

Optical Flow Engine 212 takes a temporal segment, computes optical flow between every two consecutive frames of the temporal segment, and outputs a set of flow fields (e.g., optical flow fields) that capture motion information in the temporal segment. Optical flow may be determined through interest point tracking or dense optical flow tracking. In an embodiment, optical flow engine 212 utilizes interest point tracking by selecting interest points (e.g., corner points, edges of Scale-Invariant Feature Transform (SIFT) features, etc.) from an initial frame of the temporal segment. The interest points are tracked through subsequent frames. The optical flow (e.g., flow vector) can be collected between these interest points through successive frames. In another embodiment, optical flow engine 212 may compute dense optical flow between every two consecutive frames of a temporal segment of a video sequence. Computing dense optical flow between each pair of consecutive frames may be accomplished by computing the flow vector for every pixel between the consecutive frames, by using, for example, gradient and brightness consistency constraints. Computing flow vector for every pixel results in dense trajectories during the trajectory extraction process (e.g., by trajectory extraction component 216), described further below. Therefore, as flow vector is computed for every pixel of an image, computing dense optical flow provides for more informative (e.g., denser) trajectories extracted from the segment.

A flow field (e.g., optical flow field) may include motion information for a frame in the temporal segment (tₙ), such as orientation, direction, velocity, etc., of individuals moving within a crowd. In an example, a resulting optical flow field may be a 2D histogram of flow vector magnitude and orientation (or vector magnitude and direction, etc.). The flow fields are utilized by point tracking engine 214, which can identify points within trajectories of individuals through, for example, particle advection. Unlike conventional techniques of obtaining motion information through object detection and tracking, utilizing the set of flow fields in optical flow-based particle advection preserves privacy of individuals being monitored. Point tracking engine 214 identifies and extracts motion information from the video stream. Point tracking engine 214 may employ KLT, Particle Video (PV), Large displacement optical flow method, and/or particle advection techniques. In an exemplary embodiment, point tracking engine 214 may utilize trajectory extraction component 216 to extract dense trajectories from each temporal segment.

Trajectory extraction component 216 extracts trajectories from the dense optical flow computed by optical flow engine 212. In an embodiment, trajectory extraction component 216 may utilize particle advection, which produces dense trajectories. To obtain dense trajectories, dense flow tracking may be used (e.g., tracking dense flow for every pixel between consecutive frames). For example, a particle advection component may overlay a two-dimensional (2D) grid of points (e.g., a uniform grid, G) over a first flow field (e.g., of the initial frame, e.g., current time frame, of the video sequence of a temporal segment) and initialize a point trajectory at a first point (e.g., anchor point). Trajectory extraction component 216 may concatenate the first point with corresponding points of subsequent flow fields (e.g., flow fields of subsequent time frames of the video sequence of the temporal segment) to generate a point trajectory. In another example, forward time integration techniques may be applied to each anchor point of the 2D grid, such that each anchor point can evolve (e.g., connected with corresponding points in subsequent frames) into a point trajectory, wherein each point trajectory is represented as Pⱼ={(x₁,y₁), (x₂,y₂), . . . (x_{N},y_{N})}, where x and y represent the horizontal and vertical coordinates of the anchor points along a trajectory as represented on the 2D grid. Trajectory extraction component 216 may collect the point trajectories as a set of point trajectories (e.g., T number of trajectories) for each temporal segment.

In another embodiment, potentially large computational costs due to dense flow tracking may be reduced, whereby point tracking engine 214 may sample anchor points from a uniform grid overlaid over the initial frame of the video sequence. Point tracking engine 214 may initiate a trajectory from each anchor point in the current frame and identify matched points (e.g., corresponding points) in subsequent frames. Trajectory extraction component 216 then concatenates the anchor points and matched points in the subsequent frames, to form a long trajectory. Point tracking engine 214 terminates the tracking process when the anchor point ceases its original path (e.g., when occlusions occur or when optical flow is ambiguous at the boundaries of two opposite flows), by computing a circular distance (e.g., d) between the circular angle of an anchor point (e.g., i) at a current frame t and subsequent frame t+1. Point tracking engine 214 terminates the tracking process for an anchor point i in case λ≤d, where λ is a defined threshold. Trajectory extraction component 216 may then remove noisy trajectories and outliers (e.g., caused by camera motion, etc.). The final trajectory set (e.g., Ω) extracted may represent a compressed representation of the video sequence over a time period.

Oscillatory image generator 218 may generate a compact 2D representation of trajectories. In an embodiment, oscillatory image generator 218 may compress a video's temporal information, to fit as input for training a segmentation network that accepts 2D images (e.g., an oscillatory image). For each temporal segment, trajectory conversion component 220 may convert dense trajectories (e.g., point trajectories) into a set of corresponding oscillatory image (e.g., 2D image) without losing motion information. The conversion may be accomplished through projecting the set of point trajectories onto a 2D plane. Oscillatory image generator 218 may compute the oscillation value of each trajectory. An oscillation value of each trajectory may be computed, for example, based on statistical techniques in the art, and the oscillation value is then represented on the 2D plane. An oscillatory image may correspond to each temporal segment. Thus, the resulting set of oscillatory images may include a same number of oscillatory images as the number of temporal segments derived from the original video stream. The resulting oscillatory images are provided as input to segmentation network 224. By converting the trajectories into oscillatory images, the temporal information of each temporal segment is compressed into a format appropriate for feeding and training a segmentation network 224 that requires input images of fixed size (such as 2D images). In another embodiment, oscillatory image generator 218 may convert the trajectories into spatial-temporal images. A spatial-temporal images may be binary images. As a binary image, the spatial-temporal image may have limited or lack of texture and appearance information (for example, color block). However, such binary images, which contain the connected coordinates of corresponding trajectories, can be represented as a black and white image having two color channels, which can be learned by a segmentation network 224 that can distinguish movement patterns in multiple channel images.

Segmentation network 224 may be trained by the 2D images, and learns to classify each pixel of the 2D image into two classes (e.g., congested or normal). Segmentation network 224 may output a set of segmented images, each segmented image corresponding to a 2D image (e.g., oscillatory image or spatial-temporal image), the segmented image being a graphical representation of regions of congestion or lack of congestion (e.g., normal) of a temporal segment. In an embodiment, segmentation network 224 may be a convolutional neural network (CNN) based learning model. In the example, spatial-temporal images are fed into the CNN model. The CNN model can learn representations of trajectories through the spatial-temporal images by, for example, classifying trajectories of moving objects based on classifying dominant movement patterns (e.g., of the trajectories) in the spatial-temporal image. For example, the CNN model can visualize the distribution of trajectories in a low-dimension space. In the visualization plane, trajectories that lie far away from a class of similar trajectories (e.g., that lie close to each other) are inspected. The CNN model classifies each trajectory as congested or normal accordingly. In an example, the classification may be determined based on a threshold value for congestion, such as a population density threshold, a ratio of a population density to size of an area having a density above a density baseline value, among others.

In another embodiment, can segmentation network 224 may be a binary segmentation network. In this example, oscillatory images are fed to the binary segmentation network. The binary segmentation network may determine a boundary and/or region of the set of point trajectories as depicted on the 2D plane (e.g., of the oscillatory image), to determine which portions (e.g., region) of an area of the oscillatory image are congested. The binary segmentation network may cluster together parts of an oscillatory image that belong in the same classification (e.g., congested or normal). Clustering may be done at a pixel-level (e.g., pixel-level classification). In an embodiment, a first class may be defined as congested, for example, when a region of the oscillatory image exhibits a population density (or an average density, median density, etc.) of people in a crowd per square unit (or a plurality of square units) in the region is above a threshold density. A second class may be defined as normal (e.g., uncongested) when, for example, the population density in the region is below the threshold density.

In an embodiment, the threshold density is determined by threshold engine 228. Threshold engine 228 may determine when a cluster of trajectories (e.g., determined by unsupervised learning algorithm) reaches a threshold indicating congestion for the particular area and crowd size. For example, a region of an oscillatory image may be congested when, for example, it exhibits a dense number (e.g., high number) of individuals present simultaneously. The number of individuals may be considered dense if, for example, the number of individuals per square unit of a space in a region of the oscillatory image exceeds a threshold density. The threshold density may be a predetermined value, a minimum density where crowd participants begin to experience restricted movement, an average value of threshold densities used in previous iterations of inputting oscillatory images in the binary segmentation network, etc.

Once at least an initial training has completed, testing module 226 can utilize the testing data (e.g., another set of image data) to test the trained segmentation network 224. Testing module 226 may use sets of video sequences on segmentation network 224 for testing, such as for validating the accuracy of the segmentation network's 224 classification of the 2D images as congested or normal. Testing module 226 may test for different crowd behaviors that lead to congestion, such as evacuation, jostling, conflict, blockage, among others. Testing module 226 may also compute missed detections (e.g., missed rate) by the number of missed detections (e.g., in frames) over the total number of frames in the given temporal segment.

Classifier 230 may be trained to classify whether an oscillatory image contains images of a congested crowd or normal (e.g., uncongested) crowd. Classifier 230 may include a CNN-based and/or VGG-M-based architecture. Generally, CNN architecture comprises convolutional, pooling, and fully connected layers. Classifier 230 may comprise six convolution layers and two fully connected layers. To accommodate the binary nature and the lack of texture and appearance information of spatial-temporal images, classifier 230 may enhance the receptive field of VGG-M by increasing the filter size of the first convolution layer, to incorporate more context in spatial-temporal images. To fit the input size of CNN, classifier 230 may further modify the spatial-temporal images from being single channel to three channels, by copying each individual image three times. Due to a large number of parameters of the network and limited training data, overfitting may become a problem. Therefore, a training module may employ dropout technique on the layers of the architecture. The training module may, for example, maintain a batch size of training images of 64. In an embodiment, the training module may train classifier 230 to learn the weights of different filters by stochastic gradient descent, for example, with a momentum of 0.6.

Trajectory encoding component 232 encodes each point trajectory with a classification score as determined by classifier 230. Score generator 234 generates a score map. Score generator 234 generates the score map by assigning a score value to each point of the trajectory. The values of the score map may vary from 0 to 1 (e.g., 0 representing normal trajectory and 1 representing congested trajectory). Each value of the score map may represent the confidence score obtained through the classification of the spatial-temporal images. Once the score map is obtained, a non-maximum suppression (NMS) method may be utilized to suppress low score values. A Gaussian filter may be applied to the score map, and the score map indicating congested regions may be overlaid over the video segment image (e.g., a scene of the segmented video stream). In an embodiment, segmentation network 224 may apply the Gaussian filter and overlay the resulting score map over the video segment image, creating segmented images.

Localization engine 236 may be trained to accurately localize (e.g., identify a location) a congested region. In an embodiment, localization engine 236 may be trained with a large number of positive and negative examples, and learn to discriminate congestion and normal patterns at a high number of training iterations. For example, after iterations, localization engine 236 may learn discriminative features and produce a high score for congested segments and low score for normal segments. Localization engine 236 may perform area analysis of the segmented image. Further, localization engine 236 may extract and normalize the area of congested regions. The accuracy of localization may be determined by the intersection-over-union between detected region and ground truth, based on the number of common points among detection and ground truth region, number of points in the detected region, and the number of points in the ground truth region.

FIG. 3 illustrates an exemplary congestion prediction system. Congestion prediction system 140 predicts future congestion of a crowd in an area. Congestion prediction system 140 may include segmented images data store 302, time series generator 306, long short-term memory (LSTM) component 308, congestion prediction engine 310, and detection accuracy engine 312.

Congestion prediction engine 310 may collect and process segmented images (e.g., score maps with a Gaussian filter and overlaid over the corresponding scene of a video segment) to forecast potential congestion in real-time. Congestion prediction engine 310 may process each segmented image on an independent processor parallelly to reduce the computation time and to allow for predictions to be made in real-time. Congestion prediction engine 310 trains LSTM component 308 to predict potential congestion, described further below. Segmented images data store 302 is illustrated within congestion prediction system 140 for illustration purposes. It may reside inside or outside the congestion prediction system 140, as would be readily understood to a person of ordinary skill in the art. An exemplary segmented images data store 302 includes a database for storing segmented images. Other databases may be used, as would be readily understood to a person of ordinary skill in the art, without departing from the scope of the invention.

Time series generator 306 may generate a time series list of the areas obtained from the segmented images (also referred to as temporal segments). In exemplary embodiment, time series generator 306 may accumulate the identified (e.g., localized) areas of all temporal segments from congestion detection system 120 and generate a time series list of the areas obtained from a plurality of temporal segments. For example, a list of time series (e.g., {a₀, a₁, . . . aₙ}) is obtained from the set of temporal segments (e.g., {t₀, t₁, . . . tₙ}). In an embodiment, each discrete data point in the list of time series corresponds to a temporal segment. In the example, a first data point (e.g., a₀) corresponds to a first temporal segment (e.g., t₀), a second data point (e.g., a₁) corresponds to a second temporal segment (e.g., t₁), and so forth. A data point in the list of time series can represent an area depicted in a segmented image at a particular time, the area having been scaled (e.g., normalized) with respect to areas of other segmented images associated with the set of segmented images. Hence, a list of time series may include a sequence of segmented images which represents a congestion status of at least a region of the area of the segmented images at successive, equally spaced points in time.

The time series areas are fed into long short-term memory (LSTM) component 308, or other appropriate model. Congestion prediction engine 310 trains LSTM component 308 to predict potential congestion based on the congestion patterns in the time series. In an example, congestion prediction engine 310 feeds the time series list to LSTM component 308. The time series list can be used to provide the LSTM component 308 with historical data of congestion detected within a particular region of an area covered by the segmented images, which the LSTM component 308 may use to predict future patterns of congestion within the area. In an embodiment, the LSTM component 308 may utilize anomaly detection, such as detection of casualty or injury in a crowded scene, to determine current congestion and predict future congestion. The higher accuracy of the LSTM model's ability to identify the crowd density (e.g., count accuracy) using spatial and temporal information can enable the LSTM component 308 to detect anomalies. The LSTM component 308 may also use the list of time series data to predict future patterns of congestion in similar areas, for example, a similar landscape and crowd behavior, and so forth. The predicted congestion may be visualized, for example in an interactive dashboard, in real-time.

Detection accuracy engine 312 determines the accuracy of the congestion prediction. Detection accuracy engine 312 collects true congestion values in a region and compares the true congestion values with predicted values. The number of correct predictions is divided by the total number of predictions. In an example, detection accuracy engine 312 may assign an accuracy score to each iteration of processing the time series list through the LSTM component 308. A lower accuracy score may indicate a lower prediction accuracy, and congestion prediction engine 310 may further train LSTM component 308 until the accuracy score improves (e.g., the congestion predictions of LSTM component 308 achieve a higher score).

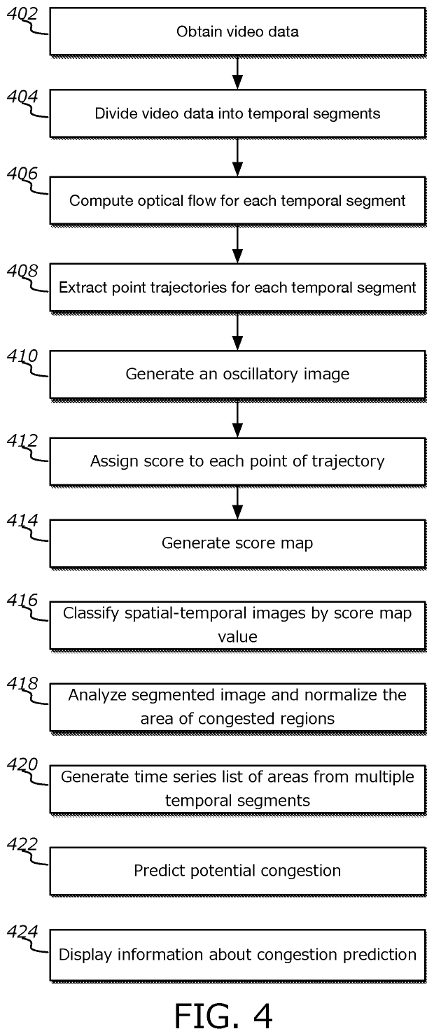

FIG. 4 illustrates an exemplary process for detecting and predicting crowd congestion in real-time in accordance with an exemplary embodiment of the present invention. The process includes obtaining 402 video data, dividing 404 the video data into temporal segments, compute 406 optical flow for each temporal segment, extract 408 point trajectories for each temporal segment, generate 410 oscillatory image, assign 412 score to each point of trajectory, generate 414 score map, classify 416 spatial-temporal images by score map value, analyze 418 segmented image and normalize the area of congested regions, generate 420 time series list of areas from multiple temporal segments, predict 422 potential congestion, and display 424 information about congestion prediction.

The process starts by obtaining 402 video data of a crowd in an area. Video data may include a video stream, such as real-time video footage, of movements of a large gathering of people in crowded scene. A scene may include a scene layout (e.g., roads, buildings, sidewalks, etc.), motion patterns (e.g., pedestrians crossing, vehicles turning, etc.), scene status (e.g., crowd congestion, crowd splitting, crowd merging, etc.), a combination thereof, and so forth. The video data may be obtained from a variety of sources, such as a plurality of cameras, drones, balloons, etc., which may be placed in various locations. Multiple sources may be used, for example, to receive video data from various angles of the particular location and/or receive video data from additional locations.

The process divides 404 the video stream into multiple temporal segments. The temporal segments may be of a fixed and/or equal size. The size of each temporal segment may be determined by the number of frames per segment. In an embodiment, temporal segments may overlap with each other. For example, a first temporal segment t₀ and second temporal segment t₁ may be of equal size (e.g., both having a length of N frames), wherein at least a final frame in the first temporal segment t₀ is the same as at least a first frame in the second temporal segment t₁.

For each temporal segment, the optical flow is computed 406. In an embodiment, the process calculates the optical flow (e.g., optical flow vector) between every two consecutive frames of the temporal segment, resulting in a set of flow fields that capture motion information in each temporal segment. For example, a resulting flow field may be a two-dimensional (2D) histogram of flow vector magnitude and orientation (or vector magnitude and direction, etc.). Each flow field may correspond to a frame in the temporal segment. Optical flow may be determined through interest point tracking and/or dense optical flow tracking. In an embodiment, the process utilizes interest point tracking by selecting interest points (e.g., corner points, edges of Scale-Invariant Feature Transform (SIFT) features, etc.) from an initial frame of the temporal segment. The interest points are tracked through subsequent frames. The optical flow can be collected between these interest points through successive frames. In another embodiment, dense optical flow may be calculated between every two consecutive frames of a temporal segment of a video sequence. Computing dense optical flow between each pair of consecutive frames may be accomplished by computing the flow vector for every pixel between the consecutive frames, by using, for example, gradient and brightness consistency constraints. Computing flow vector for every pixel of an image in a frame of the temporal segment provides for more informative (e.g., denser) trajectories extracted from the segment.

The process extracts 408 point trajectories for each temporal segment. Point trajectories may be extracted from the set of flow fields. Particle advection may be used to overlay a 2D grid of points over the first flow field. The 2D grid of points may be of an initial size W×H which covers at least a substantial portion of the first flow field. In another example, the size of the 2D grid of points may cover at least a substantial portion of flow fields in subsequent frames. The size, scale, and/or position (e.g., relative to the flow field) of the 2D grid may remain constant between the frames. A point trajectory may be initialized at each point (e.g., anchor points) of the first flow field (e.g., current time frame). The process may concatenate the anchor point with corresponding points of subsequent flow fields (e.g., flow fields of subsequent time frames of the video sequence of the temporal segment) to generate a point trajectory. In another example, forward time integration techniques may be applied to each anchor point of the 2D grid, such that each anchor point can evolve (e.g., connect with corresponding points in subsequent frames) into a point trajectory, wherein each point trajectory is represented as Pⱼ={(x₁,y₁), (x₂,y₂), . . . (x_{N},y_{N})}, where x and y represent the horizontal and vertical coordinates of the anchor points along a trajectory as represented on the 2D grid. The process may collect the point trajectories as a set of point trajectories (e.g., T number of trajectories) for each temporal segment.

The process generates 410 an oscillatory image based on the extracted trajectories, so that the motion information from the trajectories is in an acceptable format for a training model which accepts 2D images (e.g., segmentation network 224, such as a convolutional neural network (CNN) model or binary segmentation network). For example, for each temporal segment, an oscillation value of each trajectory may be computed, for example, based on statistical techniques in the art. The oscillation value corresponding to each trajectory is then projected onto the 2D plane. In another embodiment, the resulting oscillatory image may be a spatial-temporal image representing the time and space features of a trajectory as a 2D image. The spatial-temporal image may be a binary image (e.g., containing two channels, black and white). An oscillatory image may correspond to each temporal segment. Thus, a resulting set of oscillatory images may include a same number of oscillatory images as the number of temporal segments derived from the original video data. Accordingly, a plurality of sets of oscillatory images may correspond with a plurality of video data. By converting the trajectories into oscillatory images, the temporal information of each video data segment (e.g., temporal segment) is compressed into a format appropriate for feeding and training a deep learning model that accepts 2D images and classifies the oscillatory images into two classes (e.g., congested or normal).

To classify each pixel of the 2D oscillatory image as congested or normal, score is assigned 412 to each point of each trajectory. In an embodiment, the score may be assigned by a learning model which applies learned weights (e.g., from previous iterations of passing the oscillatory images through the model, such as through various filters of neural network layers of the model) in determining the score. The process may determine the score for a trajectory based on other factors, such as the behavior of the trajectory in relation to various clusters of trajectories in the spatial-temporal image, the number of similar trajectories nearby, the character of the trajectory (e.g., velocity, magnitude, etc.), a combination thereof, among others. The score can be a value within a range (e.g., between 0 and 1), where a higher value indicates that the process can detect with a higher confidence that the trajectory is congested, whereas a lower value indicates a lower confidence that congestion is detected (e.g., the trajectory is normal). A threshold value may be set to distinguish between a congested classification and normal classification. For example, a trajectory with a score at or above a threshold set to 0.6 may be classified as congested, while a trajectory with a score below 0.6 may be classified as normal. A corresponding score to the classification is encoded into each trajectory in the 2D oscillatory image. The scores are collected to generate 414 a score map. The spatial-temporal image (oscillatory image) is classified 416 by the score map value as congested or normal. The values of the score map may correspond with the collective scores of the encoded trajectories. That is, the values of the score map may vary from 0 to 1, where 0 represents a normal (e.g., uncongested) region and 1 represents a congested region. Once the score map is generated, a non-maximum suppression (NMS) method may be utilized to suppress low score values. A Gaussian filter may be applied to the score map, and the score map is overlaid over the video segment image (e.g., a scene of the segmented video stream, creating segmented images.

The process analyzes 418 the segmented images and normalizes the area of the congested regions. The segmented images may be localized, to identify the location of the congested regions. Based on the normalized segmented images, the process generates 420 a time series list of the areas from the multiple temporal segments. The time series is fed into a long short-term memory (LSTM) learning model. The process may train the LSTM learning model to predict 422 potential congestion based on the congestion patterns in the time series. Each segmented image may be processed on an independent processor parallelly to reduce computation time and to allow for making predictions in real-time. The process may display 424 information about the congestion prediction. The information may be provided, for example, through an interactive dashboard. The congested regions may be overlaid over a real-time map, and can be color-coded to indicate areas of congestion or no congestion.

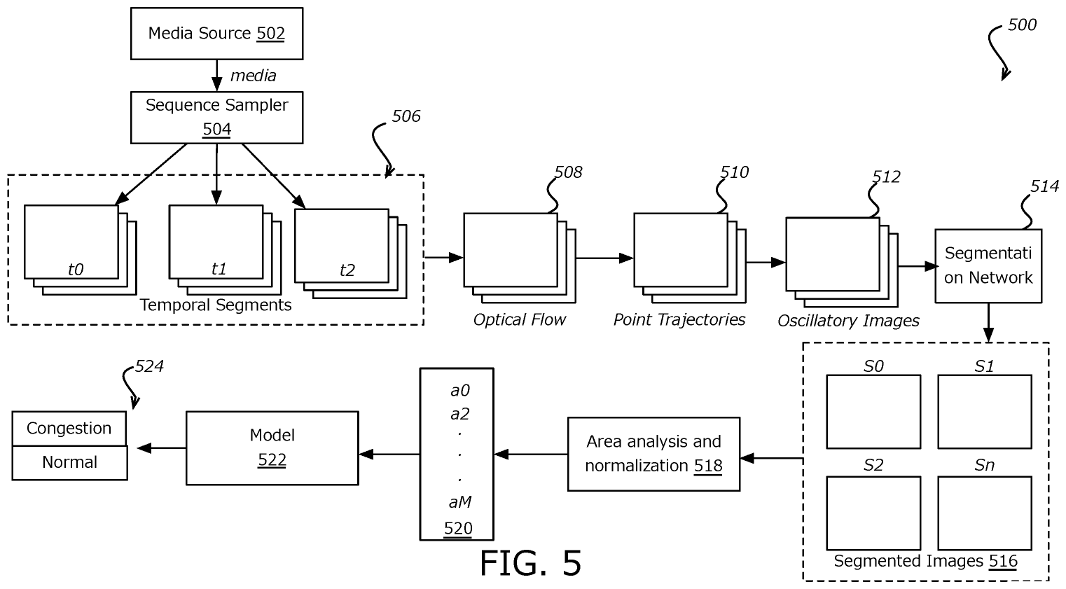

FIG. 5 illustrates an example approach 500 for detecting and predicting crowd congestion in real-time in accordance with various embodiments. In this example, a media source 502, such as a camera, drone, balloon, and the like, receives media data (e.g., video stream) of a scene which includes a large gathering in a particular location. A scene may include a scene layout (e.g., roads, buildings, sidewalks, etc.), motion patterns (e.g., pedestrians crossing, vehicles turning, etc.), scene status (e.g., crowd congestion, crowd splitting, crowd merging, etc.), a combination thereof, and so forth. The video stream may include real-time streaming footage of movement of individuals within the large gathering with respect to the location. In another embodiment, multiple media sources 502 may be used, for example, to receive media data from various angles of the particular location and/or receive media data from additional locations. The media data is collected by video sequence sampler 504, which may divide the video stream into a plurality of temporal segments 506 of fixed size (N). Therefore, each temporal segment 506 (tₙ) may include N frames. In an embodiment, the temporal segments 506 may be of equal size. In another embodiment, temporal segments 506 may overlap with each other. For example, a first temporal segment t₀ and second temporal segment t₁ may be of equal size (e.g., both having a length of N frames), wherein a set of final frames in the first temporal segment to are the same as a set of beginning frames in the second temporal segment t₁.

For each temporal segment, the system computes the optical flow between each frame to generate a set of optical flow fields 508. A flow field (e.g., optical flow field) may include motion information for a frame in the temporal segment 506 (tₙ), for example, orientation, direction, velocity, etc. of individuals moving within a crowd. Flow vectors (e.g., optical flow vector) of objects (e.g., points in the video stream) may be computed between each pair of consecutive frames within the temporal segment 506. In an embodiment, dense optical flow is computed between each pair of consecutive frames, whereby the optical flow vector can be computed for every pixel between the consecutive frames, by using, for example, gradient and brightness consistency constraints. Computing flow vector for every pixel results in dense trajectories during the trajectory extraction process, described further below. In an example, a resulting optical flow field may be a 2D histogram of flow vector magnitude and orientation (or vector magnitude and direction, etc.).

The system may extract point trajectories 510 from the set of flow fields 508. In an embodiment, particle advection is used to extract the point trajectories 510. A particle advection component may overlay a 2D grid of points (e.g., a uniform grid, G) over a first flow field (e.g., of the initial frame, e.g., current time frame, of the video sequence of a temporal segment) and initialize a point trajectory at a first point (e.g., anchor point). The 2D grid of points may be of an initial size W×H which covers at least a substantial portion of the first flow field. In another example, the size of the 2D grid of points may cover at least a substantial portion of flow fields in subsequent frames. The size, scale, and/or position (e.g., relative to the flow field) of the 2D grid may remain constant between the frames. The system may concatenate the first point with corresponding points of subsequent flow fields (e.g., flow fields of subsequent time frames of the video sequence of the temporal segment) to generate a point trajectory. In another example, forward time integration techniques may be applied to each anchor point of the 2D grid, such that each anchor point can evolve (e.g., connected with corresponding points in subsequent frames) into a point trajectory, wherein each point trajectory is represented as Pⱼ={(x₁,y₁), (x₂,y₂), . . . (x_{N},y_{N})}, where x and y represent the horizontal and vertical coordinates of the anchor points along a trajectory as represented on the 2D grid. The system may collect the point trajectories as a set of point trajectories 510 (e.g., T number of trajectories) for each temporal segment.

In another example, anchor points may be sampled from a frame of the 2D grid. Extracting point trajectories from dense optical flow (e.g., dense flow tracking) as described above can produce dense trajectories, which capture the local motion of individuals in a crowd (for example, the local motion of each pedestrian) and provide full coverage of the global context of the crowd movement. However, dense flow tracking can result in high computational costs, since flow vector is calculated for every pixel in each frame and trajectories are extracted for every pixel and its corresponding pixels in each frame. Such costs can be reduced by sampling anchor points from the uniform grid G overlaid over the first flow field (e.g., current frame, also referred to as initial frame). In an example, a first anchor point i∈G is uniquely represented by fᵢ=(x,y,Δx,Δy), where (x,y) are the spatial coordinates of the first anchor point and (Δx,Δy) is the flow vector of the first anchor point. Accordingly, F={f₁, f₂, . . . , fₙ} represents the optical flow field that contains n number of anchor points (e.g., in an anchor point set). Each anchor point i in G initiates a point trajectory in the current frame and forms a long trajectory by concatenating corresponding points in subsequent frames. This results in a set of point trajectories 510 (e.g., n number of point trajectories, each point trajectory initialized by an anchor point i in the anchor point set). The set of point trajectories 510 may be represented by Ω={t₁, t₂, . . . , tₙ}, and describes the motion in the video sequence of the temporal segment. The resulting set of point trajectories 510 are inherently dense trajectories, which give accurate information on the motion of the crowd without requiring dense flow tracking and its associated high computational costs.

A scene may include structured crowds or unstructured crowds. In structured crowd scenes, the flow of pedestrians is unique. That is, the crowd moves coherently in a common direction, the motion direction doe s not vary frequently, and each spatial location of the scene contains one main crowd behavior over time. Contrastingly, in unstructured crowd scenes, chaotic or random crowd motion is exhibited, that is, pedestrians move in arbitrary directions. For example, individuals within the crowd move in different directions at different times, and each spatial location of the scene contains multiple crowd behaviors. When a scene includes structured crowds, trajectories extracted from the scene (for example, through particle advection) are generally reliable (e.g., accurately reflect the motion of the members of the crowd). However, when a scene includes unstructured crowds, trajectories extracted from the scene become unreliable due to frequent occlusions (e.g. of flow fields) and optical flow being ambiguous at the boundaries of two opposite flows. Due to these reasons, a trajectory extracted from an anchor point may drift from the original path of the anchor point and become a part of another anchor point's motion. In one embodiment which avoids this problem, the tracking process is terminated when an anchor point ceases its original path. A circular distance d is calculated between a circular angle of the anchor point i at a first frame t and second frame t+1. A threshold λ may be defined for the circular distance. Thus, when the circular distance exceeds the threshold (e.g., λ≤d), the tracking process for the anchor point is terminated, in another example, occluded trajectories are also removed (e.g., omitted from the set of point trajectories 510). In yet another embodiment, trajectories which lack corresponding anchor points in subsequent frames are removed as well.

The system may generate oscillatory images 512 based on the extracted point trajectories. For example, for each temporal segment, the point trajectories are converted into a 2D image (e.g., an oscillatory image). The conversion may be accomplished through projecting the set of point trajectories 510 onto a two-dimensional (2D) plane. An oscillation value of each trajectory may be computed, for example, based on statistical techniques in the art, and the oscillation value is then represented on the 2D plane. An oscillatory image may correspond to each temporal segment. Thus, the set of oscillatory images 512 may include a same number of oscillatory images as the number of temporal segments derived from the original video stream. Accordingly, a plurality of sets of oscillatory images 512 may correspond with a plurality of video streams. By converting the trajectories into oscillatory images, the temporal information of each video segment (e.g., temporal segment) is compressed into a format appropriate for feeding and training a segmentation network 514 (also referred to as a binary segmentation network) that accepts 2D images. In an embodiment, segmentation network 514 may accept 2D images of a fixed size. The system trains the segmentation network 514 to classify each pixel of the 2D oscillatory image into two classes (e.g., congested or normal).

In an embodiment, segmentation network 514 may determine a boundary and/or region of the set of point trajectories 510 as depicted on the 2D plane, to determine which portions (e.g., region) of an area of the oscillatory image are congested. An area may include the entire location (e.g., environment in which the crowd is situated) covered within the oscillatory image, and a region may be a portion of the area. In the example, segmentation network 514 may cluster together parts of an oscillatory image that belong in the same classification. Clustering may be done at a pixel-level (e.g., pixel-level classification). In an embodiment, a first class may be defined as congested. A region of the oscillatory image may be congested when, for example, it exhibits a dense number (e.g., high number) of individuals present simultaneously. The number of individuals may be considered dense if, for example, the number of individuals per square unit of a space in a region of the oscillatory image exceeds a threshold density. The threshold density may be a predetermined value, a minimum density where crowd participants begin to experience restricted movement, an average value of threshold densities used in previous iterations of inputting oscillatory images in segmentation network 514, etc. A second class may be defined as normal (e.g., uncongested). In the example, a region of the oscillatory image may be normal when, for example, the density (or an average density, median density, etc.) of people in a crowd per square unit (or a plurality of square units) in the region is below a threshold density. Segmentation network 514 may output a set of segmented images 516. Thus, each oscillatory image may have a corresponding segmented image, the segmented image being a graphical representation of regions of congestion or lack of congestion (e.g., normal) of a temporal segment.

In the example, each segmented image may go through area analysis and normalization 518. The system may extract and normalize the area of congested regions detected by the segmentation network 514 for each segmented image. The area may include the entire spatial location covered within the margins of the segmented image. The area may be consistent (e.g., the same coordinates, surface area, etc., covered within the same boundaries) throughout each segmented image in the set of segmented images 516. In another embodiment, the area of a first segmented image may be defined on a different scale from the area of a second segmented image within the segmented image set 516. The areas of each segmented image may be normalized by, for example, statistically adjusting values measured on different scales between the areas of each segmented image, such that all of the areas in the set of segmented images 516 are represented on a single, common scale. The system collects areas corresponding to the temporal segments, and generates a time series list of the areas 520. For example, a list of time series 520 (e.g., {a₀, a₁, . . . aₙ}) is obtained from the set of temporal segments (e.g., {t₀, t₁, . . . tₙ}). In an embodiment, each discrete data point in the list of time series 520 corresponds to a temporal segment. In the example, a first data point (e.g., a₀) corresponds to a first temporal segment (e.g., t₀), a second data point (e.g., a₁) corresponds to a second temporal segment (e.g., t₁), and so forth. A data point in the list of time series 520 can represent an area depicted in a segmented image at a particular time, the area having been scaled (e.g., normalized) with respect to areas of other segmented images associated with the set of segmented images 516. Thus, a list of time series 520 can include a sequence of segmented images which represent a congestion status of at least a region of the area of the segmented images at successive, equally spaced points in time.

The system feeds the time series areas to a long short-term memory (LSTM) learning model 522 or other appropriate model. In an embodiment, the system may train the LSTM model 522 to predict potential congestion based on the time series list 520. The time series list 520 may be used to provide the LSTM model 522 with historical data of congestion detected within a particular region of an area covered by the segmented images, which the LSTM model 522 may use to predict future patterns of congestion 524 within the area. In an embodiment, the LSTM model 522 may utilize anomaly detection, such as detection of casualty or injury in a crowded scene, to determine current congestion and predict future congestion. The higher accuracy of the LSTM model's 522 ability to identify the crowd density (e.g., count accuracy) using spatial and temporal information can enable the LSTM model 522 to detect anomalies. The LSTM model 522 may also use the list of time series data 520 to predict future patterns of congestion in similar areas, for example, a similar landscape and crowd behavior, and so forth. The predicted congestion may be visualized, for example in an interactive dashboard, in real-time.

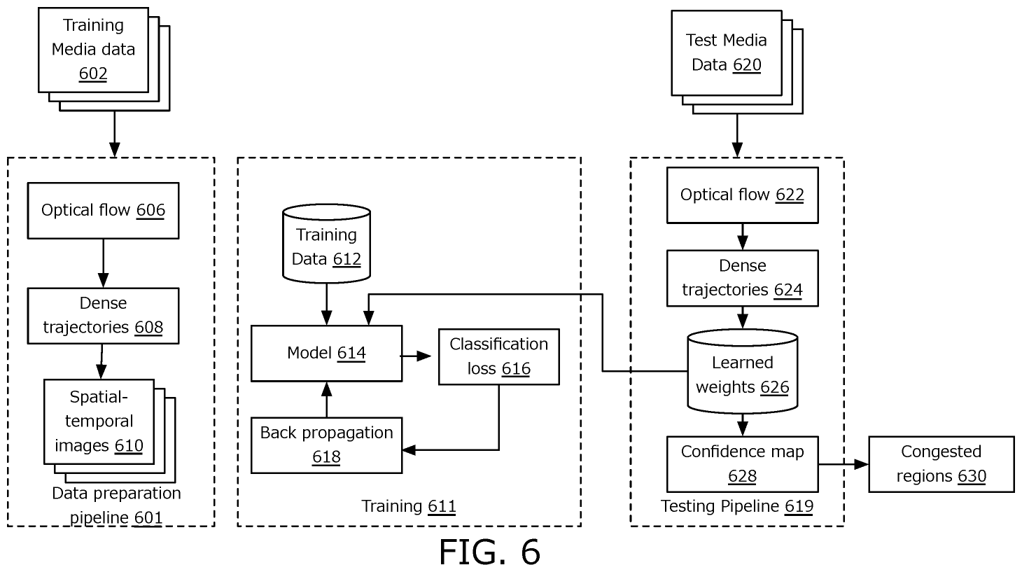

FIG. 6 illustrates another example process for detecting and predicting crowd congestion in real-time in accordance with an embodiment of the invention. The system receives training media data 602, for example a first video sequence (e.g., video stream). The training media data 602 may be collected from a media source such as a camera, drone, balloon, and the like. The video sequence may include real-time streaming footage of a crowded scene, such as the movement of individuals in a large gathering in a particular location. Multiple media sources may be used to collect a plurality of video sequences from various angles of the particular location and/or collect a plurality of video sequences from additional locations. The crowded scene may include a scene layout (e.g., roads, buildings, sidewalks, etc.), motion patterns (e.g., pedestrians crossing, vehicles turning, etc.), scene status (e.g., crowd congestion, crowd splitting, crowd merging, etc.), a combination thereof, and so forth. The crowded scene may be a complex scene, meaning conventional image processing of the scene may experience disturbances to object detection and tracking due to background clutter, diverse configuration in layouts and appearances, illumination changes, occlusions, object distortion, etc. that can result from the presence of a high-density crowd in the area.

In an embodiment, the training media data 602 is divided into a plurality temporal segments. Each temporal segment (tₙ) includes a plurality of frames. In an embodiment, each of the temporal segments may be of fixed size (e.g., N frames). In another embodiment, the temporal segments may be of equal size. In another embodiment, temporal segments may overlap with each other. For example, a first temporal segment t₀ and second temporal segment t₁ may be of equal size (e.g., both having a length of N frames), wherein at least a final frame in the first temporal segment t₀ is the same as at least a beginning frame in the second temporal segment t₁.

The system prepares 601 the segmented training media data 602 (e.g., temporal segments) to train a training model 611 to detect and predict congestion in an area covered by the training media data 602. For each temporal segment, optical flow 606 (e.g., dense optical flow, or optical flow vector or flow vector) between each frame (e.g., corresponding points between consecutive frames in the segmented training media data 602) to generate a set of flow fields (e.g., optical flow fields). A flow field may include motion information for a frame in the temporal segment (tₙ), such as orientation, direction, velocity, and the like, of participants moving within a crowd. In an example, a flow field may be a 2D histogram of optical flow vector magnitude and orientation (or vector magnitude and direction, etc.). To compute the optical flow 606 (e.g., dense optical flow) between frames, the system may utilize techniques such as coarse-to-fine warping techniques, or other techniques known in the art for computing optical flow fields. In another embodiment, dense optical flow 606 is computed by calculating the optical flow vector for every pixel between the consecutive frames, by using, for example, gradient and brightness consistency constraints. The computed dense optical flow is then projected onto a 2D plane as a set of flow fields, wherein each flow field may correspond to a frame in the temporal segment.

In an embodiment, dense trajectories 608 (also referred to as point trajectories) are extracted from the resulting set of flow fields. When the set of flow fields is generated based on computing dense optical flow 606, trajectories which are extracted from such flow fields are inherently dense because the flow vector is computed for every pixel between frames in each temporal segment. In an embodiment, the system may utilize particle advection to extract dense trajectories 608 from the set of flow fields. For example, a 2D grid of points (e.g., a uniform grid) is laid over a first flow field (e.g., of the first frame of a temporal segment). The 2D grid of points may be of an initial size W×H, covering at least a substantial portion of the first optical flow field. In another example, the size of the 2D grid of points may cover at least a substantial portion of optical flow fields in subsequent frames. The size, scale, and/or position (e.g., relative to the flow field) of the 2D grid may remain constant between the frames. An anchor point (e.g., first point) is initialized in the first frame, the anchor point representing the initial point of a trajectory. The anchor point is concatenated with corresponding points of subsequent flow fields (e.g., optical flow fields of subsequent time frames of the temporal segment) to generate a dense trajectory. Concatenating a plurality of anchor points in the first flow field with their respective corresponding points in subsequent flow fields results in a set of dense trajectories 608 representing the collective trajectories of participants in the large gathering for a single temporal segment.

In another embodiment, dense trajectories 608 may be extracted from a sampling of sample anchor points from the 2D grid laid over the first frame (e.g., the first flow field). Extracting point trajectories from dense optical flow (e.g., dense flow tracking) produces dense trajectories 608, which capture the local motion of individuals in a crowd (e.g., the local motion of each pedestrian) and provide full coverage of the global context of the crowd movement. However, because flow vector is calculated for every pixel in each frame and trajectories are then extracted for every pixel and its corresponding pixels in subsequent frames, dense flow tracking can result in high computational costs. Such costs can be reduced by sampling anchor points from the uniform grid overlaid over the first flow field (e.g., current frame, also referred to as initial frame). For example, a first anchor point i∈G is uniquely represented by fᵢ=(x,y,Δx,Δy), where (x,y) are the spatial coordinates of the first anchor point and (Δx,Δy) is the flow vector of the first anchor point. Accordingly, F={f₁, f₂, . . . , fₙ} represents the flow field that contains n number of anchor points (e.g., in an anchor point set). Each anchor point i in G initiates a point trajectory in the current frame and forms a long trajectory by concatenating corresponding points in subsequent frames. This results in a set of dense trajectories (e.g., n number of dense trajectories, each dense trajectory initialized by an anchor point i in the anchor point set). The set of dense trajectories 608 may be represented by Ω={t₁, t₂, . . . , tₙ}, and describes the motion in each temporal segment of the training media data 602. The resulting set of dense trajectories are inherently dense, which give accurate information on the motion of the crowd without requiring dense flow tracking and its associated high computational costs.

Concatenation of dense trajectories 608 may be terminated when an anchor point ceases its original path, drift into another anchor point's motion, and so forth. For example, an anchor point may cease its original path when occlusions occur or when optical flow is ambiguous at the boundaries of two opposite flows, which may occur during a scene where the crowd is unstructured (e.g., chaotic or random crowd motion is exhibited, that is, pedestrians move in arbitrary directions and the scene exhibits multiple crowd behaviors). In this situation, the system may compute a circular distance (e.g., d) between the circular angle of an anchor point (e.g., i) at a current frame t and subsequent frame t+1. A threshold λ may be defined for the circular distance. Thus, when the circular distance exceeds the threshold (e.g., λ≤d), concatenation of further points to the anchor point is terminated.

In another embodiment, noisy trajectories and outliers (e.g., caused by camera motion, etc.) may be removed from the set of dense trajectories 608. For example, occluded trajectories resulting from the motion of anchor points drifting into each other may be removed from the set of dense of trajectories. Camera motion may also contribute to generating noisy trajectories. Noisy trajectories may be removed by rectifying the image (e.g., the concatenated trajectory as rendered on the uniform grid G) to compensate for the camera motion. If the displacement vector in the warped vector field is too small, the trajectory is regarded as noise and removed. After pruning noisy trajectories, the final set Ω of dense trajectories 608 may represent a compressed representation of the training media data 602 over a time period.

In an embodiment, the extracted dense trajectories 608 are converted into 2D images (e.g., spatial-temporal images 610, also referred to as trajectory images). A spatial-temporal image may include a binary image containing connected points (e.g., coordinates) of the dense trajectory. The spatial-temporal image may have limited or lack of texture and appearance information (for example, color block). However, a convolutional neural network (CNN) classifier or other such model 614 can learn representations of trajectories, such as by classifying trajectories of moving objects based on classifying dominant movement patterns using multiple channel images. Trajectory data (e.g., the set of dense trajectories) extracted from different scenes can have different spatial ranges due to, for example, the resolution of the training media data 602, among others. In order to feed the trajectory data as training input to such a learning model 614, such data needs to be of fixed size. Hence, in an embodiment, when the dense trajectories are converted into 2D images, the images are set to a fixed size (e.g., a fixed size which fits the input size accepted by the learning model 614). Moreover, spatial-temporal images 610 are binary images which can include, for example, a blank (e.g., white) background and pixels corresponding to trajectory data (e.g., dense trajectories) coded in black color. In an embodiment, the spatial-temporal images 610 may be converted from the dense trajectories according to Algorithm 1, below. After generating the spatial-temporal images 610, the spatial-temporal images 610 are pre-processed by subtracting each spatial-temporal image from the image mean (e.g., the mean of the image set). The input to Algorithm 1 is a set of dense trajectories represented by Ω={t₁, t₂, . . . tₙ}, and the output is a set of normalized spatial-temporal images represented by Iₘ.

Algorithm 1: Generating spatial-temporal images from trajectories

```
Input: Trajectories (Ω [symbol]   wᵢ, hᵢ, wₒ, hₒ)
Output: List of spatio-temporal images [symbol]
  1: Begin
  2:  Foreach trajectories tₖ in Ω do
  3:  Initialize I ∈ [symbol] [symbol]       ← 1
  4:  Foreach point p in t do
$\text{5:} \text{?} = \text{?}$
$\text{6:} \text{?}$
  7:  if 0 ≤ [symbol]    ≤ wₒ and 0 ≤ [symbol]    ≤ [symbol]    hₒ then
  8:  I( [symbol]  ) ← 0
  9:  EndIf
10:  Endfor
11:  Insert
12:  EndFor
13:  Initialized I
$\text{14:} {I}_{mean} \text{?} // \text{compute mean of image set} \text{?}$
15:  Foreach image M in [symbol]    do
16:  d ← [symbol]    − M
17:  insert d in [symbol]
18:  EndFor
19:  return [symbol]
20: End [symbol]
indicates data missing or illegible when filed
```

Training block 611 trains the CNN classifier or other model 614 with the spatial-temporal images 610. Training data 612 (e.g., training images) can include spatial-temporal images 610, or other 2D images converted from trajectory data collected from temporally segmented video sequences. The system further refines the training data 612, for example by employing t-distributed stochastic neighbor embedding (t-SNE). For example, the system visualizes the distribution of trajectories in a low-dimension space. In the visualization plane, trajectories that lie far away from a class of similar trajectories (e.g., that lie close to each other) are inspected. The training data 612 is further refined based on the inspection of the trajectories displaced from the class. The training data 612 is used to train the model 614. The model 614 may be trained with classification loss (e.g., loss functions) 616 and back propagation 618 as known in the art. In the example, the weights 626 of different filters of the model 614 are learned by stochastic gradient descent with momentum of 0.6. The model 614 classifies each spatial-temporal image 610 as congested or normal. In an example, the classification may be determined based on a threshold value for congestion, such as a population density threshold, a ratio of a population density to size of an area having a density above a density baseline value, among others. In another embodiment, model 614 may also learn to localize the area, that is, identify the location (e.g., area) of the crowd, the regions within the area which exhibit congestion, and so forth.

Pipeline 619 validates (e.g., tests the accuracy of) the classification and/or localization of model 614 on video streams of crowded scenes. A test set of test media data 620 is fed into the model 614. Test media data 620 may be received from a variety of different sources and proprietary databases, such as surveillance footage, balloons, drones, etc. In an embodiment, test media data 620 may include a second video sequence (e.g., where training media data 602 includes a first video sequence). In one example, the second video sequence may cover the same or substantially the same area (e.g., location) as that of training media data 602. In another example, the second video sequence may cover a different area from that of test media data 602, and/or a different time frame from that of training media data 602. Test media data 620 is divided into a plurality of temporal segments. The temporal segments may be overlapping. In an embodiment, the temporal segments may be of fixed size (e.g., having N frames) and/or equal size. For each temporal segment, optical flow 622 (e.g., dense optical flow) is computed between each frame, to generate a set of flow fields. Each flow field may include motion information corresponding to a frame in the temporal segment, such as orientation, direction, velocity, and the like, of participants moving within a crowd. In an example, a flow field may be a 2D histogram of optical flow vector magnitude and orientation, vector magnitude and direction, etc. The dense optical flow 622 between each frame may be computed by calculating the optical flow vector for every pixel between consecutive frames (e.g., by gradient and brightness constraints). The dense optical flow is then projected onto a 2D plane as a set of flow fields, each flow field corresponding to a frame in the temporal segment.

Dense trajectories 624 may be extracted from the resulting set of flow fields. In an embodiment, a 2D grid of points (e.g., a uniform grid) is laid over a first flow field (e.g., of the first frame in the temporal segment). An anchor point (e.g., first point) is initialized in the first frame, the anchor point representing the initial point of a dense trajectory. The anchor point is concatenated with corresponding points of subsequent flow fields (e.g., of subsequent frames of the temporal segment) to generate a dense trajectory. Concatenating a plurality of anchor points in the first flow field with their respective corresponding points in subsequent flow fields results in a set of dense trajectories 624 representing the collective trajectories of participants in the large gathering for the temporal segment. In another embodiment, dense trajectories 624 may be extracted from a sampling set of anchor points from the 2D grid laid over the first frame. For example, a first anchor point i∈G is represented by fᵢ=(x,y,Δx,Δy), where (x,y) are the spatial coordinates of the first anchor point and (Δx,Δy) is the flow vector of the first anchor point. Thus, F={f₁, f₂, . . . , fₙ} represents the flow field that contains n number of anchor points (e.g., in an anchor point set). Each anchor point tin G initiates a point trajectory in the first frame and forms a long trajectory by concatenating corresponding points in subsequent frames. This results in a set of dense trajectories (e.g., n number of dense trajectories, each dense trajectory 624 initialized by an anchor point t in the anchor point set). The resulting set of dense trajectories may be represented by Ω={t₁, t₂, . . . , tₙ}, and describes the motion in each temporal segment of the media data 620.

In an embodiment, noisy trajectories and outliers may be removed from the set of dense trajectories 624. For example, camera motion and other factors may cause trajectory data to be corrupt, such as exhibiting ambiguous boundaries from two opposite flows, occlusions with other trajectories, drifting away from its anchor point's original motion and into a different or unusual motion, etc. Such trajectories may be removed. In another embodiment, such trajectories may be corrected by rectifying the image (e.g., the concatenated trajectory as rendered on the uniform grid G) to compensate for the camera motion. After pruning noisy trajectories, the final set Ω of dense trajectories 624 may represent a compressed representation of the media data 620 over a time period.

In another embodiment, the set of dense trajectories 624 may be annotated, for example, to efficiently examine and label trajectories (e.g., as opposed to manual examination and labeling) when the set of dense of trajectories 624 is be scaled (e.g., may represent thousands of crowd participants in one scene). For example, unsupervised clustering may be employed to cluster the dense trajectories into a plurality of groups. Trajectories belonging to a prominent (e.g., big cluster) group may be regarded as normal trajectories, while a second cluster (e.g., containing a smaller number of trajectories than in the prominent group) of dense trajectories 624 may be regarded as congested trajectories. Labels may be assigned to the various clusters (e.g., congested or normal), as well as any dense trajectories set far away from the clusters (e.g., outliers). In the situation where further refinements to the annotations are needed, for example, where two similar trajectories are assigned to two different classes when they should be assigned to the same class, various statistical methods may be used. For example, t-distributed stochastic neighbor embedding (t-SNE) or other statistical methods for high dimensional data visualization may be employed to further refine the set of trajectories by visualization the distribution of the dense trajectories in a low-dimension space. Thus, in the visualization plane, trajectories which are similar will lie close to each other. Any remaining trajectories which lie far from the classes in the visualization plane may be further inspected.

The set of dense trajectories 624 are converted into a set of spatial-temporal images (e.g., a binary image containing the connected points of the dense trajectories), as described above. The spatial-temporal images may be fed to model 614, which classifies the set of spatial-temporal images as congested or normal. In an embodiment, model 614 may also localize the spatial-temporal images (e.g., identify the area covered by the spatial-temporal images). Learned weights 626 may be applied to various filters (e.g., in at least one neural network layer) in the model 614 to classify and/or localize the spatial-temporal images. For example, during training 611, the weights of a plurality of filters of the model 614 may be learned by stochastic gradient descent with a momentum of 0.6. The learned weights 626 may be updated (e.g., via back propagation 618), for example, after each iteration of passing training media data 602 through model 614 during training. During pipeline 619 (e.g., testing of the model 614), the learned weights 626 includes the latest updated values of weights from training block 611. The learned weights 626 are applied to the model 614 in classifying and/or localizing the set of spatial-temporal images (e.g., converted from the extracted dense trajectories 624).

In an embodiment, dense trajectories 624 can be classified based on an assigned score. For example, for each spatial-temporal image, model 614 assigns each trajectory a score. The score can be a value within a range (e.g., between 0 and 1), where a higher value indicates that the model 614 can detect with a higher confidence that the trajectory is congested, whereas a lower value indicates a lower confidence that that congestion is detected (e.g., the trajectory is normal). A threshold value may be set to distinguish between a congested classification and normal classification. For example, a trajectory with a score at or above a threshold set to 0.6 may be classified as congested, while a trajectory with a score below 0.6 may be classified as normal. The model 614 may determine the score for a trajectory based on various factors, such as the application of the learned weights 626 in filtering the trajectories of the spatial-temporal image, the behavior of the trajectory in relation to various clusters of trajectories in the spatial-temporal image, the number of similar trajectories nearby, the character of the trajectory (e.g., velocity, magnitude, etc.), a combination thereof, among others.

Model 614 can assign a list of scores to the spatial-temporal images, to generate a confidence map 628 (e.g., a score map). The confidence map 628 may comprise a plurality of coordinates (e.g., of an area covered by the spatial-temporal images) that are associated with a visual representation of a plurality of levels of confidence that indicate which regions of a scene are congested. In an embodiment, the confidence map 628 (e.g., LP) may be generated using Algorithm 2, below.

Algorithm 2: Generating score map ψ
Input: List ofTrajectories Ω = {t₁, t₂, ... , tₙ}
Classification scores S = {S₁, S₂, ... , Sₙ}
Output: Score map ψ
1: Begin
2: Initialize ψ ϵ [symbol] ^{w}^{ᵢ}^{xh}^{ᵢ} ← 0
3: Foreach trajectories tₖ in Ω do
4: Foreach point (xᵢ, yᵢ) in trajectories tₖ do
5: ψ(xᵢ,yᵢ) ← 0
6: EndFor
7: EndFor
8: End

In the embodiment, the set of dense trajectories 624 is represented as Ω={t₁, t₂, . . . , tₙ} and their corresponding scores represented as S={S₁, S₂, . . . , S_{N}}. The resolution of the confidence map 628 may be equal to the resolution of the original video frame (e.g., [symbol] ^{w}^{ᵢ}^{×h}^{ᵢ}). Each of the set of dense trajectories 624 is encoded with its respective classification score. For example, the values of the confidence map 628 may vary from 0 to 1, where a score closer to 0 represents a normal trajectory and a score closer to 1 represents a congested trajectory. In an embodiment, confidence map 628 may be encoded with a color bar. For example, a higher score is encoded in red representing congested trajectories, while normal trajectories are encoded in blue. The system may apply non-maximum suppression (NMS) method, or other such methods, to confidence map 628 to suppress low score values, to identify congested locations. Low score values may be defined by a predetermined threshold for distinguishing between the congested and normal classifications. For example, a threshold value may be fixed at 0.6. Thus, all points on congestion map 628 with scores lower than 0.6 may be suppressed. After suppressing low scores with NMS, a Gaussian filter may be applied, for example, where a is 1 and with a size of 15×15 pixels. Small blobs which appear after applying the Gaussian filter may be clustered together (e.g., belonging to congested regions), by using, for example, mean-shift method or other such statistical methods. The resulting regions represent the congested regions in the scene. The final visualization of the detected congested regions 630 is overlaid on the video segment.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

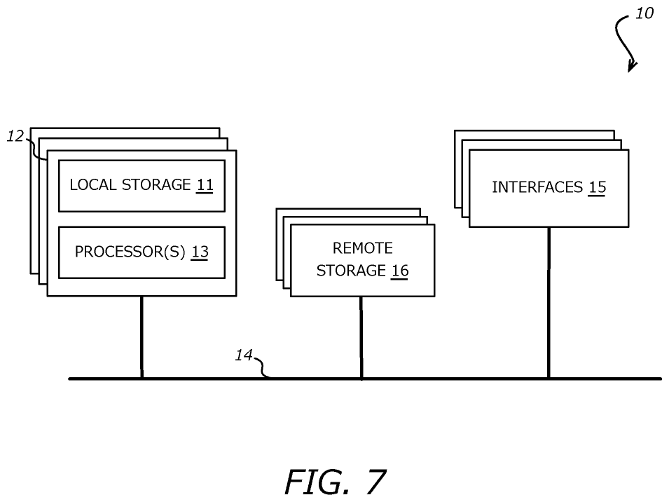

Referring now to FIG. 7 above, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 7 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a JAVA virtual machine or equivalent, or files containing higher level code that may be executed by the computer using an interpreter (for example, scripts written in Python, Perl, Ruby, Groovy, or any other scripting language).

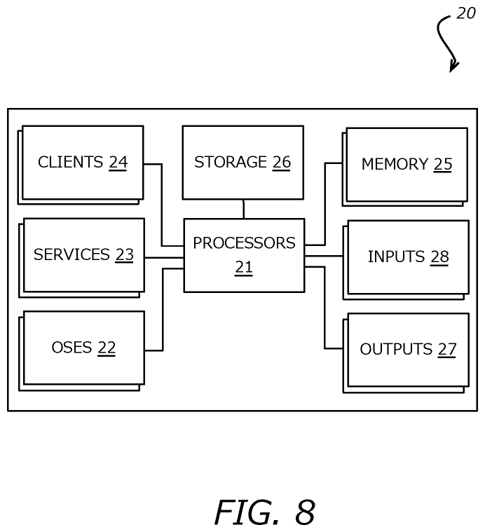

In some embodiments, systems may be implemented on a standalone computing system. Referring now to FIG. 8 above, there is shown a block diagram depicting a typical exemplary architecture of one or more embodiments or components thereof on a standalone computing system. Computing device 20 includes processors 21 that may run software that carry out one or more functions or applications of embodiments, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID′ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 5). Examples of storage devices 26 include flash memory, magnetic hard drive, CD-ROM, and/or the like.

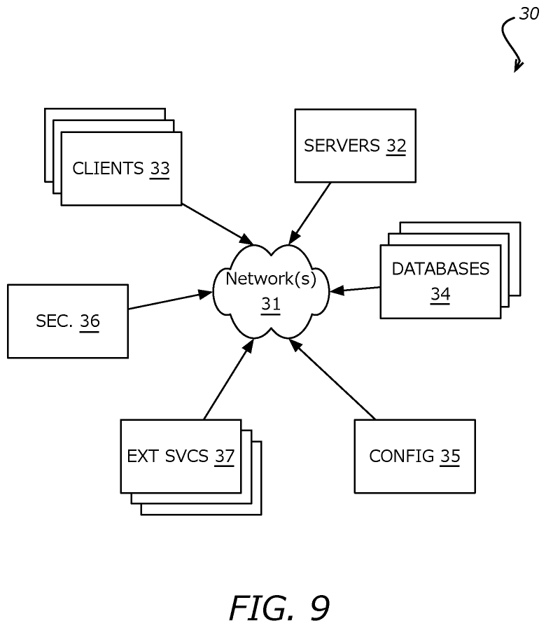

In some embodiments, systems may be implemented on a distributed computing network, such as one having any number of clients and/or servers. Referring now to FIG. 9 above, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™ GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

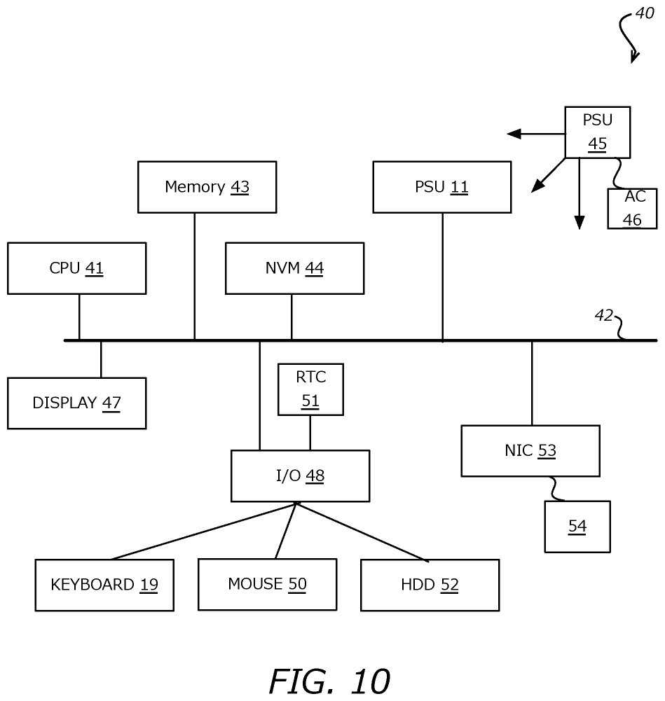

FIG. 10 above shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. MC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### ADDITIONAL CONSIDERATIONS

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computing system, comprising:
a computing device processor; and
a memory device including instructions that, when executed by the computing device processor, enables the computing system to:
segment a length of video data into a plurality of temporal segments,
determine a set of optical flow fields for each of the plurality of temporal segments,
extract a plurality of trajectories from each optical flow field of the set of optical flow fields,
convert the plurality of trajectories into a training set of oscillatory images by projecting the plurality of trajectories onto a two-dimensional (2D) plane,
analyze the training set of oscillatory images to determine a score for each of the plurality of trajectories, the score indicating a degree of congestion,
generate a score map to classify whether a geographic region of a temporal segment is congested, and
graphically representing at least one classification to visually specify a level of congestion for the geographic region.

2. The computing system of claim 1, wherein the instructions, when executed by the computing device processor, further enables the computing system to:
train a long short-term memory model to predict future congestion.

3. The computing system of claim 1, wherein the instructions, when executed by the computing device processor, further enables the computing system to:
provide a visualization of congestion in an interactive dashboard in real-time.

4. The computing system of claim 1, wherein each of the plurality of temporal segments includes a fixed size, the fixed size defined by a number of frames of the video data.

5. The computing system of claim 1, wherein each oscillatory image from the training set of oscillatory images is a binary image.

6. The computing system of claim 1, wherein the instructions, when executed by the computing device processor, further enables the computing system to:
calculate an optical flow field between every two consecutive frames of each temporal segment.

7. The computing system of claim 1, wherein extracting the plurality of trajectories from each optical flow field further comprises concatenating an initial point in a first frame of the temporal segment with a corresponding point in a second frame of the temporal segment.

8. The computing system of claim 1, wherein the instructions, when executed by the computing device processor, further enables the computing system to:
select the geographic region of the temporal segment,
generate a time series list of geographic regions from the plurality of temporal segments, and
feed the time series list of geographic regions to a long short-term memory model.

9. The computing system of claim 1, wherein the score may be determined by a segmentation network, the segmentation network to classify each pixel in a trajectory from the plurality of trajectories as one of congested or uncongested.

10. The computing system of claim 1, wherein a congested classification corresponds to when the score exceeds a density threshold.

11. A non-transitory computer readable storage medium storing instructions that, when executed by at least one processor of a computing system, causes the computing system to:
segment a length of video data into a plurality of temporal segments,
determine a set of optical flow fields for each of the plurality of temporal segments,
extract a plurality of trajectories from each optical flow field of the set of optical flow fields,
convert the plurality of trajectories into a training set of oscillatory images by projecting the plurality of trajectories onto a two-dimensional (2D) plane,
analyze the training set of oscillatory images to determine a score for each of the plurality of trajectories, the score indicating a degree of congestion,
generate a score map to classify whether a geographic region of a temporal segment is congested, and
graphically representing at least one classification to visually specify a level of congestion for the geographic region.

12. The non-transitory computer readable storage medium of claim 11, wherein the instructions, when executed by the at least one processor, further enables the computing system to:
train a long short term memory model to predict future congestion.

13. The non-transitory computer readable storage medium of claim 11, wherein the instructions, when executed by the at least one processor, further enables the computing system to:
provide a visualization of congestion in an interactive dashboard in real-time.

14. The non-transitory computer readable storage medium of claim 11, wherein each of the plurality of temporal segments includes a fixed size, the fixed size defined by a number of frames of the video data.

15. The non-transitory computer readable storage medium of claim 11, wherein each oscillatory image from the training set of oscillatory images is a binary image.

16. The non-transitory computer readable storage medium of claim 11, wherein the instructions, when executed by the at least one processor, further enables the computing system to:
calculate an optical flow field between every two consecutive frames of each temporal segment.

17. The non-transitory computer readable storage medium of claim 11, wherein extracting the plurality of trajectories from each optical flow field further comprises concatenating an initial point in a first frame of a temporal segment with a corresponding point in a second frame of the temporal segment.

18. The non-transitory computer readable storage medium of claim 11, wherein the instructions, when executed by the at least one processor, further enables the computing system to:
select the geographic region of a temporal segment,
generate a time series list of geographic regions from the plurality of temporal segments, and
feed the time series list of geographic regions to a long short-term memory model.

19. The non-transitory computer readable storage medium of claim 11, wherein the score may be determined by a segmentation network, the segmentation network to classify each pixel in a trajectory as one of congested or uncongested.

20. The non-transitory computer readable storage medium of claim 11, wherein a congested classification corresponds to when the score exceeds a density threshold.
